(19) United States
(12) Patent Application Publication
(10) Pub. No.: US 2016/0330169 A1
(43) Pub. Date: Nov. 10, 2016

(54) BASE STATION FOR IP COMMUNICATIONS WITH MOBILE TERMINAL, AND METHOD FOR ACQUIRING IP OF BASE STATION

(71) Applicant: Electronics and Telecommunications Research Institute, Daejeon-si (KR)

(72) Inventor: Jong Choul YIM, Daejeon-si (KR)

(21) Appl. No.: 15/148,024

(22) Filed: May 6, 2016

(30) Foreign Application Priority Data
May 7, 2015 (KR) 10-2015-0064064

(51) Int. Cl. H04L 29/12; H04W 60/00; H04L 29/08; H04W 48/16

(52) U.S. Cl. CPC H04L 61/2007; H04W 48/16; H04L 61/1511; H04W 60/00; H04L 67/02

(57) ABSTRACT

A base station and a method of acquiring an IP of a base station by a mobile terminal. According to one exemplary embodiment, a base station includes: an application server to store an application provided to a mobile terminal; a wireless access node to perform wireless communications with the mobile terminal; and a proxy server to manage information of the application server and register an entire domain name of the wireless access node and an IP address thereof to a domain name-IP address conversion server.

### CROSS-REFERENCE TO RELATED APPLICATION(S)

This application claims the benefit under 35 U.S.C. §119(a) of Korean Patent Application No. 10-2015-0064064, filed on May 7, 2015, in the Korean Intellectual Property Office, the entire disclosure of which is incorporated herein by reference for all purposes.

### BACKGROUND

1. Field

The following description relates to a technology for a mobile terminal to acquire the internet protocol (IP), and more particularly, to a technology for acquiring the IP of a base station so as to be provided with an application service by the base station.

2. Description of the Related Art

A recent mobile terminal accesses a mobile communications network wirelessly over a radio access network (RAN); can access the Internet through the IP assigned by a packet core of the mobile communications network; and can be provided with contents from a content server connected to the Internet. Here, data packets, which are generated when the mobile terminal performs communications using an IP with the content server connected to the Internet, should pass through E-UTRAN Node B (eNodeB), and Serving Gateway (SGW) and Packet Gateway (PGW) of a mobile communications core network. If the content server is not connected to the Internet, but is equipped in the eNodeB, the mobile terminal can more quickly access the content server, which leads to a reduction in traffic of a packet core of the mobile communications network. Under the circumstances above, a technology for a smart base station is recently being developed.

In order to provide a service, such as content provision using a smart base station, a mobile terminal should communicate with the smart base station by using the IP connection. Thus, the mobile terminal is required to know the IP of the smart base station. Under the circumstances of the mobile terminal, as the mobile terminal moves, the mobile terminal leaves a wireless access range of a base station, with which the mobile terminal currently communicated, and performs hand-off to a new base station. Here, the base station, accessed by the mobile terminal, is changed, which results in a change in the IP of the base station. If one fixed piece of IP information of the base station is set in the mobile terminal, the mobile terminal cannot communicate with a new base station by using an IP when a handoff is performed, which necessarily occur in a mobile communications environment. Thus, in order to provide a service base on a smart base station, what is required is an effective method of not setting a fixed IP of a base station in a mobile terminal, but finding out an IP of the base station.

### SUMMARY

The purpose of the following application is to provide a base station and method of acquiring an IP of the base station so as to acquire an IP address of the base station that the mobile terminal currently is accessing and acquire application information running in the base station, so that a mobile terminal can be provided with various services through IP communications with the base station.

In one general aspect, a base station includes: a wireless access node to perform wireless communications with a mobile terminal; and a proxy server to register an entire domain name of the wireless access node and an IP address thereof to a domain name-IP address conversion server, wherein the wireless access node broadcasts a signal including a wireless access node ID so that the mobile terminal accesses.

The proxy server may generate the entire domain name by interpreting the wireless access node ID as a number and combining a character-type wireless access node ID with a domain name of a mobile communications carrier, wherein the character-type wireless access node ID is acquired by adding characters to the number.

The base station may further include an application server to provide a service to a mobile terminal, wherein the applications server may request the proxy server to register application information.

The application information may include an application ID and access information.

In response to the registration request, the proxy server may register the application information to application DB information.

The application DB information may include at least one of an application ID, an application name, an application access port number, an application description, an application developer, and an application URL.

In response to a request for an application list from the mobile terminal, the proxy server may transmit the application list to the mobile terminal.

In another general aspect, a method of acquiring an IP of a base station includes: generating an entire domain name of a wireless access node; registering the entire domain name and an IP address to a domain name-IP address conversion server; and broadcasting a signal including a wireless access node ID so that a mobile terminal accesses.

The generating of the entire domain name may include: generating the entire domain name by interpreting the wireless access node ID as a number and combining a character-type wireless access node ID with a domain name of a mobile communications carrier, wherein the character-type wireless access node ID is acquired by adding characters to the number.

The method may further include: registering application information in installing an application.

The application information may include an application ID and access information.

The registering of the application information may include: in response to an application information registration request, registering the application information to application DB information.

The application DB information may include at least one of an application ID, an application name, an application access port number, an application description, an application developer, and an application URL.

The method may further include: in response to a request for an application list from the mobile terminal, transmitting the application list to the mobile terminal.

Other features and aspects may be apparent from the following detailed description, the drawings, and the claims.

### BRIEF DESCRIPTION OF THE DRAWINGS

FIG. 1 is a diagram illustrating a mobile communications system for IP communications between a mobile terminal and a base station, according to an exemplary embodiment.

FIG. 2 is a diagram illustrating a base station according to an exemplary embodiment.

FIG. 3 is a diagram illustrating a process for performing IP communications between a base station and a mobile terminal, according to an exemplary embodiment.

FIG. 4 is a flowchart illustrating a method for acquiring an IP of a base station for IP communications between a mobile terminal and a base station, according to an exemplary embodiment.

FIG. 5 is a flowchart illustrating a method of generating an entire domain name according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of a base station for IP communications with a mobile terminal, and a method of acquiring an IP of the base station thereof are specifically described with reference to figures.

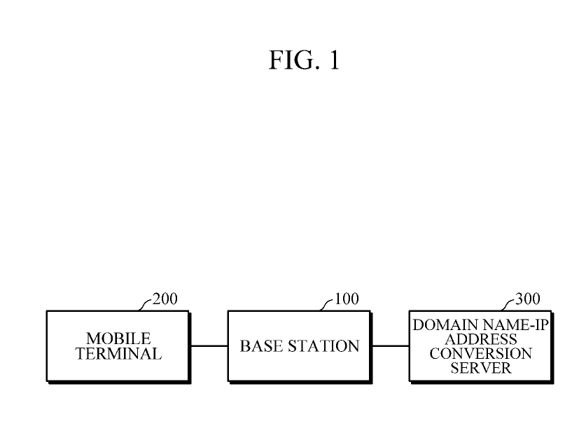

FIG. 1 is a diagram illustrating a mobile communications system for IP communications between a mobile terminal and a base station, according to an exemplary embodiment.

Referring to FIG. 1, a mobile communications system may include a mobile terminal 200, a base station 100, and a domain name-IP address conversion server 300.

The mobile terminal 200 may receive a broadcast signal from a wireless access node so as to access the wireless access node. For example, the broadcast signal may be the master information block (MIB) or the system information block (SIB), which is periodically transmitted. Here, a 24-bit wireless access node ID may be included in the SIB. If a wireless access is completely performed to the wireless access node, the mobile terminal 200 calculates a character-type ID value of the wireless access node by using the wireless access node ID, and acquires an entire domain name of a smart base station by combining the ID value with a stored name of a mobile communications carrier. The mobile terminal 200 may request an entire domain name to the domain name-IP address conversion server 300 so as to acquire an IP address of the base station 100 that the mobile terminal currently accesses. The mobile terminal 100 receives a response to the request, and in its own storage, stores an IP address for the entire domain name of the base station 100, which is included in the response. The mobile terminal 200 may request an application server that runs in the base station 100 to perform a specific instruction by using the acquired IP address of the base station 100

The base station 100 may additionally include a function for a proxy server in the function of the wireless access node. Also, the base station may include an application server for providing a particular service to a mobile terminal. The base station 100 performs registering the entire domain name and IP address of the wireless access node to the domain name-IP address conversion server, and also performs managing the information of the application server that runs in the base station 100. The detailed description for the base station 100 will be disclosed later.

The domain name-IP address conversion server 300 may be a domain name system (DNS) server or a dynamic domain name system (DDNS) server. The DNS server is a system providing a service that is performed between a computer and a network service, which include a hierarchy structure of the domain; and provides a function for acquiring an IP address of a specific host by requesting the IP address with respect to the specific host, connected to an IP-based network, by using a fully qualified domain name (FQDN). Thus, the mobile terminal may acquire the FQDN of the base station, and if the FQDN has been registered to the DNS in advance, an IP address of the base station may be acquired by requesting the IP address by using the FQDN of the base station.

The DDNS server refers to a DNS server, in which a host in an IP network can dynamically register its own FQDN and IP address.

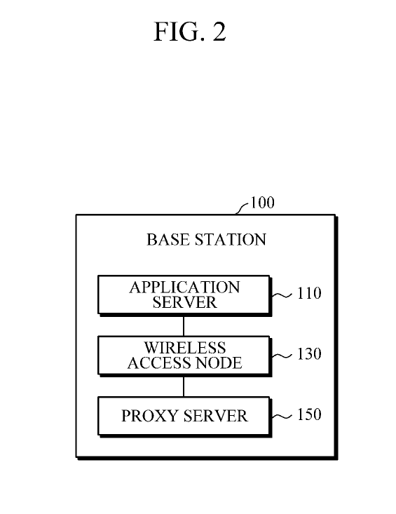

FIG. 2 is a diagram illustrating a base station according to an exemplary embodiment.

Referring to FIG. 2, a base station 100 may include an application server 110, a wireless access node 130, and a proxy server 150.

The application server 110 may provide a service to a mobile terminal, wherein the service may include a content sharing service and a chat service. According to the exemplary embodiment, the base station 100 may include a content sharing application server 110 that shares content, such as a video, among mobile terminals, which access the base station. The mobile terminal may upload content, included in itself, to the content sharing application server 110 that runs in the base station 100, or may download content from the content sharing server existing in the base station.

In another exemplary embodiment, the base station 100 may include a chat application server 110 that can make possible real-time chatting among mobile terminals that access the base station.

The wireless access node 130 may perform wireless communications with the mobile terminal. For example, the wireless access node 130 may be at least one of eNodeB, Relay Node, Home eNodeB, and a combined wireless access processor that can simultaneously perform eNodeB and user equipment (UE) functions.

In another example, the wireless access node 130 may broadcast a signal including a wireless access node ID so as to help the mobile terminal's access. For example, the broadcast signal may be the master information block (MIB) or the system information block (SIB), which is periodically transmitted. Here, a 24-bit wireless access node ID may be included in the SIB.

The proxy server 150 may register an entire domain name and IP address of the wireless access node 130 to the domain name-IP address conversion server 300. In one exemplary embodiment, the entire domain name may be an FQDN. The proxy server 150 may transmit a DNS update request to the domain name-IP address conversion server 300 according to a procedure, set in the standard of RFC2136, so as to send the IP and entire domain of the base station to the domain name-IP address conversion server 300. The domain name-IP address conversion server 300 may perform the process in response to the DNS update request, and transmit the result to the proxy server 150.

In another exemplary embodiment, the proxy server 150 may interpret a wireless access node ID as a number, and combine a character-type wireless access node ID, acquired by adding characters to number, with a domain name of a mobile communications carrier so as to generate an entire domain name.

If the wireless access node 130 is, for example, eNodeB, the proxy server 150 may acquire an IP of the wireless access node 130. Here, the IP of the wireless access node may be statically set or dynamically assigned. In another example, if the wireless access node is a combined wireless access processor, in which Relay Node and UE functions are combined, the proxy server 150 may acquire an IP, which is acquired from the packet data network gateway (PGW) in a mobile communications carrier network.

The wireless access node 130 includes an ID that can only identify itself, which is called ‘a wireless access node ID’. The proxy server 150 may acquire the wireless access node ID from the wireless access node 130.

In one exemplary embodiment, the proxy server 150 may interpret the wireless access node ID as a decimal number, thereby acquiring and changing the wireless access node ID into a series of characters. Then, the character of ‘n’ may be added to the front of the series of characters. The resultant is called ‘a character-type ID of a wireless access node’. For example, if a value of a number-type ID of a wireless access node is ‘65004’, a character-type ID thereof is ‘n65004’. The proxy server 150 includes a domain name of a mobile communications carrier, which is stored therein, or may acquire a domain name by requesting it to the wireless access node 130. For example, ‘mkt.com’ may be a domain name of a specific mobile communications carrier. Here, the proxy server 150 may generate an entire domain name of the wireless access node by adding a character-type ID of the wireless access node to a domain name of the mobile communications carrier. For example, if a domain name of the mobile communications carrier is ‘mkt.com’, and a character-type ID is ‘n65004’, the entire domain name of a base station may be ‘n65004.mkt.com’.

In another exemplary embodiment, the proxy server 150 may transmit a DNS update request according to a procedure, set in the standard of RFC2136, so as to register an IP and entire domain name of the base station to a domain name-IP address conversion server. The DNS update request includes the contents of requesting the addition of record A to the DNS, wherein the entire domain name of the base station may fill the field of NAME, and an IP address of the base station may fill RDATA.

The application server 110 may request a registration of application information to the proxy server 150 when installing an application.

The application information may include an application ID and access information. The application ID may refer to an ID for identifying an application, and is unique in a mobile communications carrier network. The access information may refer to a port number that can be used when a mobile terminal accesses the application.

The proxy server 150 may register the application information to application DB information in response to the request thereof. For example, the application DB information may be at least one of the following: an application ID, an application name, an application access port number, an application description, an application developer, and an application URL.

The proxy server 150 may in response to a request for an application list from the mobile terminal, transmit the application list to the mobile terminal. For example, the mobile terminal may request an application list to the proxy server 150 existing in a base station. Here, if the proxy server 150 receives an application information request message, the proxy server 150 may check the information on the application that runs in the application server 110. Then, the proxy server 150 may transmit the checked application list to the mobile terminal.

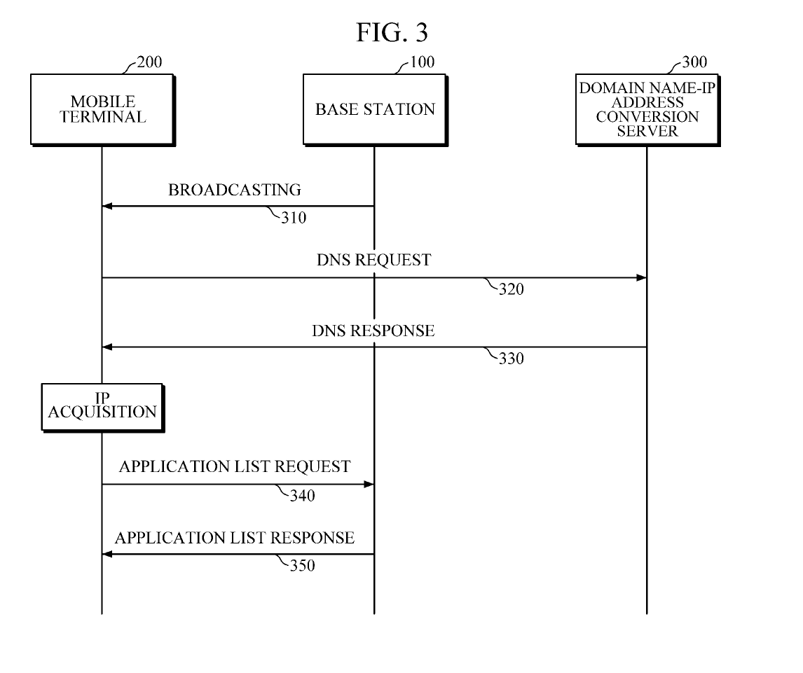

FIG. 3 is a diagram illustrating a process for performing IP communications between a base station and a mobile terminal, according to an exemplary embodiment.

Referring to FIG. 3, a base station 100 may transmit a broadcast signal to communicate with a mobile terminal in 310. For example, a wireless access node 130 of the base station 100 may broadcast a signal including a wireless access node ID so that a mobile terminal can access the base station 100. Here, the broadcast signal may be the master information block (MIB) or the system information block (SIB), which is periodically transmitted. In addition, a 24-bit wireless access node ID may be included in the SIB.

Then, the mobile terminal 200 combines the ID of the wireless access node, which is included in the broadcast signal, and a domain name of a mobile communications carrier, which is stored in the mobile terminal, thereby making an entire domain name of the base station, and by using the entire domain name, may request a DNS to a domain name-IP address conversion server 300 in 320, and receive a DNS response from the domain name-IP address conversion server 300 in 330. Here, the DNS response includes an IP address for the entire domain name of the base station. Thus, based on the description above, the mobile terminal may acquire an IP address of the wireless access node 130.

Then, the mobile terminal 200 accesses the base station 100 to request, in 340, an application list including information on an application running in the base station, which then may provide the application list that the mobile terminal 200 has requested. Here, if a proxy server 150 receives an application information request message of the mobile terminal, the proxy server 150 may check the application information in a DB, which stores the application information. Then, the proxy server 150 may transmit the checked application list to the mobile terminal.

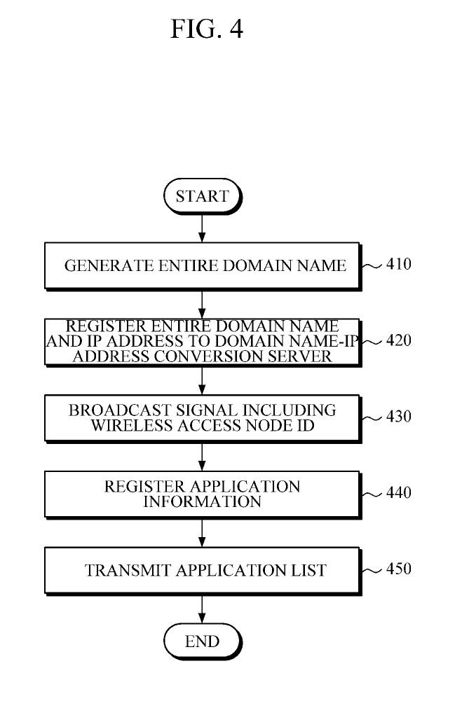

FIG. 4 is a flowchart illustrating a method for acquiring an IP of a base station for IP communications between a mobile terminal and a base station, according to an exemplary embodiment.

Referring to FIG. 4, a base station 100 generates an entire domain name of a wireless access node in 410. For example, the base station 100 may register an entire domain name and

IP address of a wireless access node to a domain name-IP address conversion server 300. For example, the entire domain name may be a fully qualified domain name (FQDN).

Then, the base station 100 registers the entire domain name and IP address to the domain name-IP address conversion server in 420. For example, the base station 100 may transmit a DNS update request to the domain name-IP address conversion server 300 according to a procedure, set in the standard of RFC2136, so as to transmit the IP of the base station 100 and the entire domain thereof to the domain name-IP address conversion server 300. The domain name-IP address conversion server 300 may perform the process in response to the DNS update request, and transmit the result to the proxy server 150.

Then, the base station 100 broadcast a signal including a wireless access node ID so that the mobile terminal can access the base station 100 in 430. For example, the base station may use the master information block (MIB) or the system information block (SIB), which is periodically transmitted. Here, a 24-bit wireless access node ID may be included in the SIB.

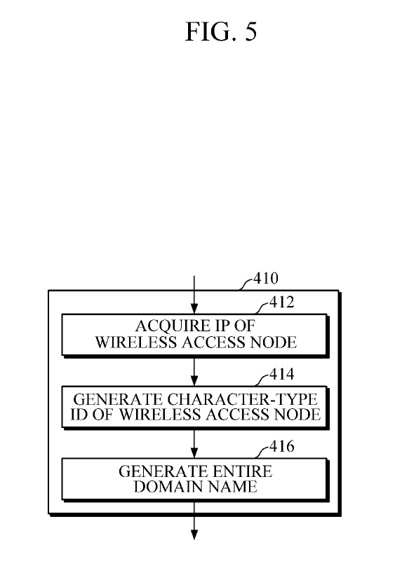

In another exemplary embodiment, the base station 100 may interpret a wireless access node ID as a number, and combine a character-type wireless access node ID, acquired by adding characters to number, with a domain name of a mobile communications carrier so as to generate an entire domain name. The description thereof will be disclosed later with reference to FIG. 5.

In yet another exemplary embodiment, the base station 100 registers application information, in 440, when installing an application. For example, if a new application is installed in the base station 100, the base station 100 may register information on the application running in the base station 100.

The application information may include an application ID and access information. For example, the application ID may refer to an ID for identifying an application, and is unique in a mobile communications carrier network. The access information may refer to a port number that can be used when a mobile terminal accesses the application.

The base station 100 may register the application information to application DB information in response to the request thereof. For example, the application DB information may be at least one of the following: an application ID, an application name, an application access port number, an application description, an application developer, and an application URL.

The application DB information may be at least one of the following: an application ID, an application name, an application access port number, an application description, an application developer, and an application URL.

The base station 100 may in response to a request for an application list from the mobile terminal, transmit the application list to the mobile terminal in 450. For example, the mobile terminal may request an application list existing in a base station. Here, if the base station 100 receives an application information request message, the base station 100 may check the information on the application that runs in the base station 100. Then, the base station 100 may transmit the checked application list to the mobile terminal.

FIG. 5 is a flowchart illustrating a method of generating an entire domain name according to an exemplary embodiment.

Referring to FIG. 5, a base station acquires its internal a wireless access node IP in 412. For example, if the internal wireless access node is, for example, eNodeB, the proxy server inside the base station may acquire an IP of the wireless access node. Here, the IP of the wireless access node may be statically set or dynamically assigned. In another example, if the wireless access node is a combined wireless access processor, in which Relay Node and UE functions are combined, the proxy server may acquire an IP, which is acquired from the packet data network gateway (PGW) in a mobile communications carrier network.

The wireless access node of the base station 100 includes an ID that can only identify itself, which is called ‘a wireless access node ID’. The proxy server may acquire the wireless access node ID from the wireless access node.

Then, the base station 100 generates a character-type ID of the wireless access node in 414. The base station 100 may interpret the wireless access node ID as a decimal number, thereby acquiring and changing the internal wireless access node ID of the base station into a series of characters. Then, the character of ‘n’ may be added to the front of the series of characters. The resultant is called ‘a character-type ID of a wireless access node’. For example, if a value of a number-type ID of a wireless access node is ‘65004’, a character-type ID thereof is ‘n65004’.

Then, the base station 100 generates an entire domain name in 416. Here, the base station 100 may store and keep a domain name of a mobile communications carrier. For example, ‘mkt.com’ may be a domain name of a specific mobile communications carrier. Here, the base station 100 may generate an entire domain name of the wireless access node by adding a character-type ID of the wireless access node to a domain name of the mobile communications carrier. For example, if a domain name of the mobile communications carrier is ‘mkt.com’, and a character-type ID is ‘n65004’, the entire domain name of a base station may be

The present disclosure is to, if a mobile terminal accesses a new base station, acquire an IP address of the base station and information on an application running in the base station, so that a mobile terminal can perform a IP-based direct communications with the base station, which leads to an effect that a user can more quickly use an application service so as to reduce the traffic of a packet core of a mobile communications network.

The methods and/or operations described above may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A base station, comprising:
a wireless access node configured to perform wireless communications with a mobile terminal; and
a proxy server configured to register an entire domain name of the wireless access node and an IP address thereof to a domain name-IP address conversion server,
wherein the wireless access node is configured to broadcast a signal including a wireless access node ID so that the mobile terminal accesses.

2. The base station of claim 1, wherein the proxy server is configured to generate the entire domain name by interpreting the wireless access node ID as a number and combining a character-type wireless access node ID with a domain name of a mobile communications carrier, wherein the character-type wireless access node ID is acquired by adding characters to the is number.

3. The base station of claim 1, further comprising:
an application server configured to provide a service to a mobile terminal, wherein the applications server is configured to request the proxy server to register application information.

4. The base station of claim 3, wherein the application information comprises an application ID and access information.

5. The base station of claim 3, wherein in response to the registration request, the proxy server is configured to register the application information to application DB information.

6. The base station of claim 5, wherein the application DB information comprises at least one of an application ID, an application name, an application access port number, an application description, an application developer, and an application URL.

7. The base station of claim 1, wherein in response to a request for an application list from the mobile terminal, the proxy server is configured to transmit the application list to the mobile terminal.

8. A method of acquiring an IP of a base station, the method comprising:
generating an entire domain name of a wireless access node;
registering the entire domain name and an IP address to a domain name-IP address conversion server; and
broadcasting a signal including a wireless access node ID so that a mobile terminal accesses.

9. The method of claim 8, wherein the generating of the entire domain name comprises:
generating the entire domain name by interpreting the wireless access node ID as a number and combining a character-type wireless access node ID with a domain name of a mobile communications carrier, wherein the character-type wireless access node ID is acquired by adding characters to the number.

10. The method of claim 8, further comprising:
registering application information in installing an application.

11. The method of claim 10, wherein the application information comprises an application ID and access information.

12. The method of claim 10, wherein the registering of the application information comprises:
in response to an application information registration request, registering the application information to application DB information.

13. The method of claim 12, wherein the application DB information comprises at least one of an application ID, an application name, an application access port number, an application description, an application developer, and an application URL.

14. The method of claim 8, further comprising:
in response to a request for an application list from the mobile terminal, transmitting the application list to the mobile terminal.
